(19) United States
(12) Patent Application Publication
(10) Pub. No.: US 2013/0099023 A1
(43) Pub. Date: Apr. 25, 2013

(54) FLUID EJECTION DEVICE

(71) Applicants: Sang Youl JEON, Seoul (KR); Hee Ju SON, Suwon (KR); Bo Sung KU, Suwon (KR)

(72) Inventors: Sang Youl JEON, Seoul (KR); Hee Ju SON, Suwon (KR); Bo Sung KU, Suwon (KR)

(73) Assignee: SAMSUNG ELECTRO-MECHANICS CO., LTD.

(21) Appl. No.: 13/408,486

(22) Filed: Feb. 29, 2012

(30) Foreign Application Priority Data
Oct. 25, 2011 (KR) 10-2011-0109261

(51) Int. Cl. F02M 51/00

(52) U.S. Cl. 239/71; 239/533.2

(57) ABSTRACT

There is provided a fluid ejection device, including a piezo pipette head ejecting a first fluid; a solenoid valve head disposed to be adjacent to the piezo pipette head and ejecting a second fluid having a volume relatively larger than that of the first fluid; and a fluid collection unit allowing the second fluid ejected from the solenoid valve head to be formed thereon to thereby allow the volume of the second fluid to be measured by an optical image device.

### CROSS-REFERENCE TO RELATED APPLICATIONS

This application claims the priority of Korean Patent Application No. 10-2011-0109261 filed on Oct. 25, 2011, in the Korean Intellectual Property Office, the disclosure of which is incorporated herein by reference.

### BACKGROUND OF THE INVENTION

1. Field of the Invention

The present invention relates to a fluid ejection device, and more particularly to a fluid ejection device allowing various volumes of fluids to be ejected from a single device.

2. Description of the Related Art

In conducting research using bio-chips, it is very important to supply a fixed quantity of fluid such as a culture medium or reagent to bio-chips to determine the accuracy of experimental results.

A fixed quantity supply of fluid is more important in cell chips essentially requiring a toxicity test, an anticancer drug sensitivity test, and an anticancer drug resistance test to develop new medicines.

According to the related art, in supplying fluids such as a culture medium or a reagent to bio-chips, a fluid ejection device including a ceramic nozzle connected to a pump unit through a tube has mainly been used.

Although such a fluid ejection device may adjust the amount of ejected fluid through electronic controlling, since a minimal amount of droplets supplied through the ceramic nozzle may be several tens of μl, it may be difficult to supply a fixed quantity of fluid, and to provide a fine amount of fluid.

To solve this problem, an ejection device capable of supplying liquid droplets of a few nk or less according to electronic controlling has been developed.

However, the ejection device capable of supplying liquid droplets of a few nk may not adjust the volume of an ejected fluid, and types of ejection devices vary depending on the volumes of the ejected fluid.

That is, separate fluid ejection devices need to be used according to the volumes of ejected fluids, which may cause inconvenience in using fluid ejection devices as well as causing a problem in terms of cost.

In addition, fluid ejection devices need to be alternately used according to volumes of ejected fluids, increasing time required for exchanging or operating experiment devices, and the concentration of an experimenter may be degraded to cause a lowering of precision of the experiment.

Furthermore, if fluids ejected from a single fluid ejection device are different, ejection conditions may need to be inconveniently reset.

### SUMMARY OF THE INVENTION

An aspect of the present invention provides a fluid ejection device allowing various volumes of fluids to be ejected from a single device and measuring the volume of a fluid to be ejected before the fluid is ejected to a bio-chip, or the like, thereby improving accuracy in a fixed quantity supply of the fluid.

According to an aspect of the present invention, there is provided a fluid ejection device, including: a piezo pipette head ejecting a first fluid; a solenoid valve head disposed to be adjacent to the piezo pipette head and ejecting a second fluid having a volume relatively larger than that of the first fluid; and a fluid collection unit allowing the second fluid ejected from the solenoid valve head to be formed thereon to thereby allow the volume of the second fluid to be measured by an optical image device.

The fluid collection unit may include a hydrophobic water repellent coated surface.

The fluid collection unit may allow the second fluid ejected from the solenoid valve head to be formed to have a spherical shape.

The optical imaging device may image the first fluid ejected from the piezo pipette head or the second fluid formed on the fluid collection unit to thereby allow the volume of the first fluid or the second fluid to be measured.

The optical imaging device may include an image inspection region to correspond to an image of the first fluid or the second fluid in order to accurately measure the volume of the first fluid or the second fluid.

The fluid ejection device may further include a setting control unit controlling a voltage applied to the piezo pipette head or a voltage application time or controlling a valve opening time applied to the solenoid valve head when a numerical value of the volume of the first fluid or the second fluid measured by the optical image device exceeds a pre-set numerical value range of volume.

The fluid ejection device may further include a transfer unit allowing the piezo pipette head and the solenoid valve head to move simultaneously or individually.

The fluid ejection device may further include a pump provided to suck the first fluid and the second fluid stored in the piezo pipette head and the solenoid valve head, respectively.

The fluid ejection device may further include an environment control unit controlling a temperature or humidity of a surrounding environment of the piezo pipette head or the solenoid valve head.

The fluid ejection device may further include an air blower drying a surface of the fluid collection unit on which the second fluid is formed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a fluid ejection device according to an embodiment of the present invention;

FIG. 2 is a schematic front view of the fluid ejection device according to the embodiment of the present invention;

FIG. 3 is a schematic enlarged cross-sectional view of part A shown in FIG. 2 after a solenoid valve head moves to a location corresponding to a fluid collection unit;

FIG. 4 is a conceptual diagram for explaining the fluid ejection device according to the embodiment of the present invention;

FIG. 5 is a schematic view showing an image of a first fluid that is ejected from a piezo pipette head, captured by an optical imaging device provided in the fluid ejection device according to the embodiment of the present invention;

FIG. 6A is a schematic view showing an image of a second fluid after being immediately ejected from a solenoid valve head captured by the optical imaging device provided in the fluid ejection device according to the embodiment of the present invention; and

FIG. 6B is a schematic view showing an image of the second fluid in contact with a fluid collection unit after being ejected from the solenoid valve head captured by the optical imaging device provided in the fluid ejection device according to the embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

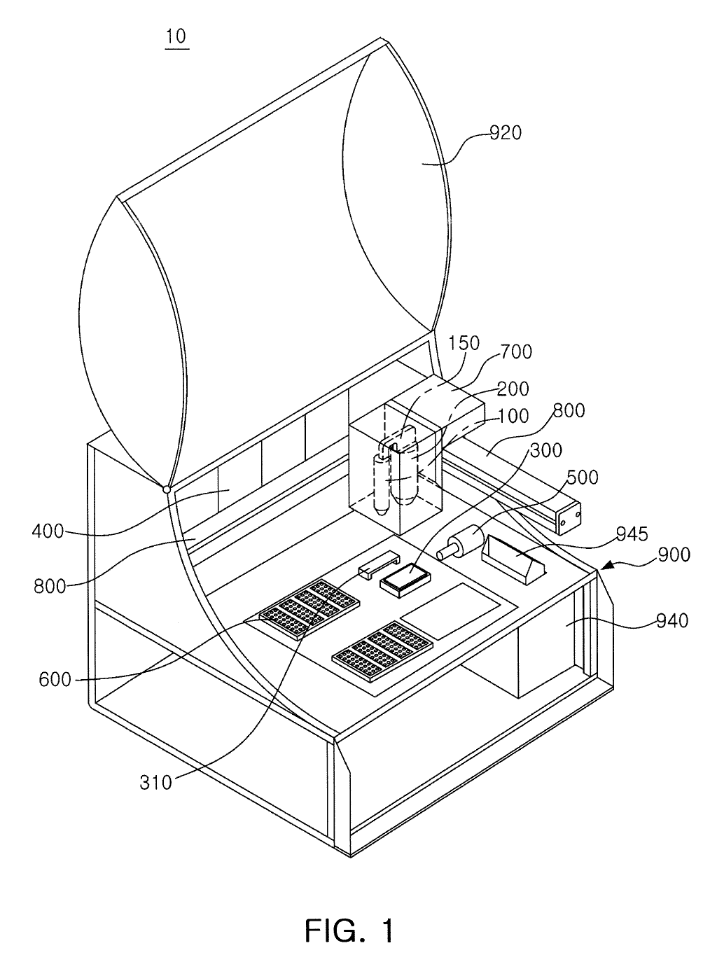

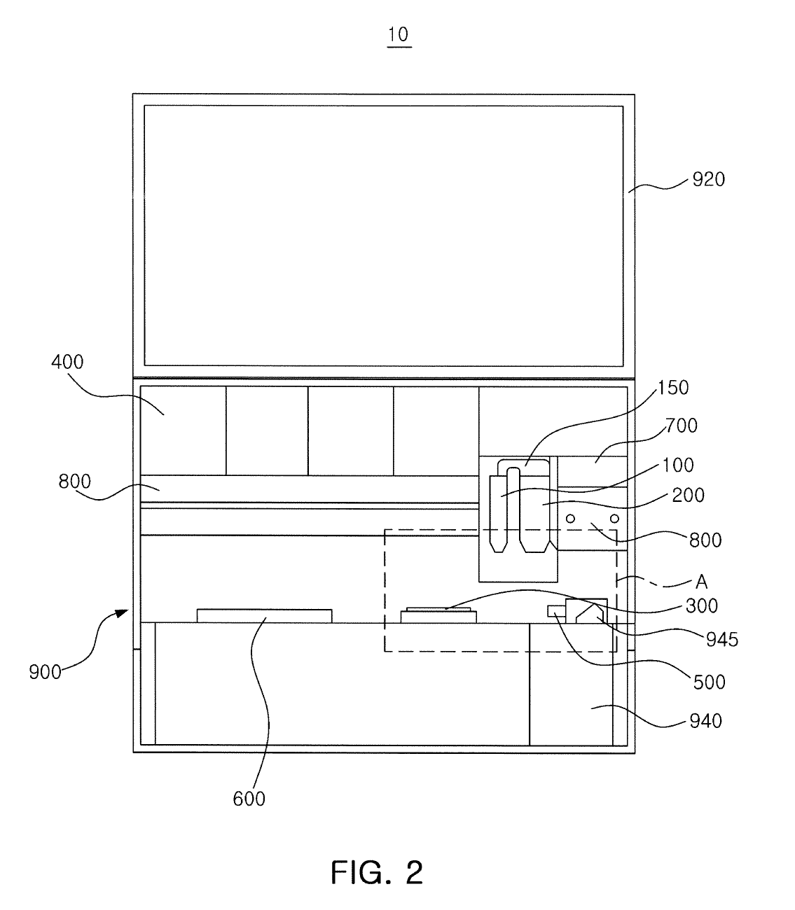

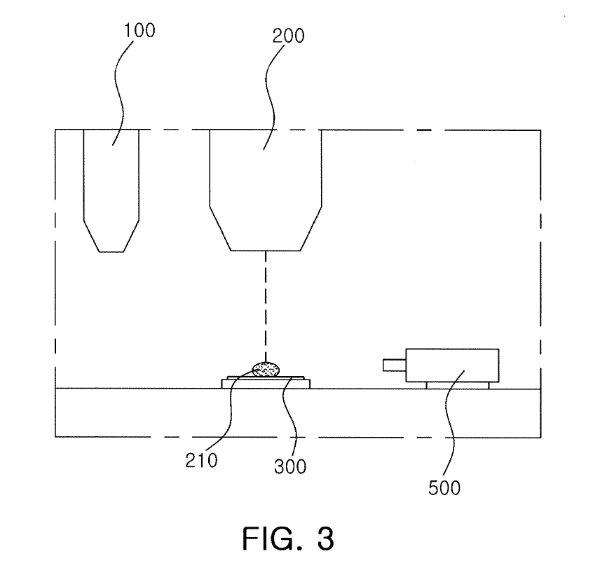

FIG. 1 is a schematic perspective view of a fluid ejection device according to an embodiment of the present invention. FIG. 2 is a schematic front view of the fluid ejection device according to the embodiment of the present invention. FIG. 3 is a schematic enlarged cross-sectional view of part A shown in FIG. 2 after a solenoid valve head moves to a location corresponding to a fluid collection unit.

Referring to FIGS. 1 through 3, a fluid ejection device 10 according to an embodiment of the present invention may include a piezo pipette head 100, a solenoid valve head 200, and a fluid collection unit 300.

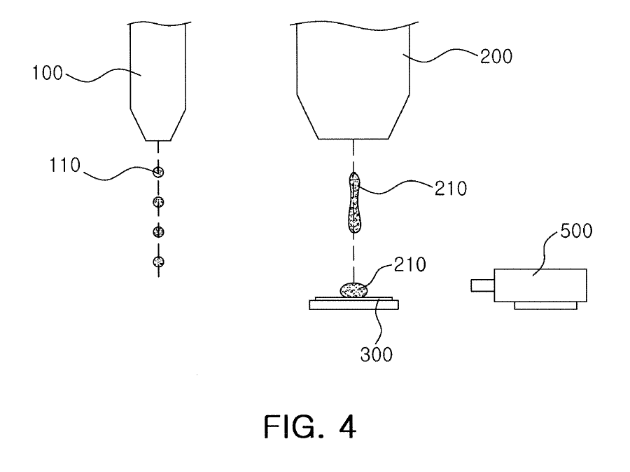

The Piezo pipette head 100 may be an element for ejecting a first fluid (110 in FIG. 4) having a volume relatively smaller than that of a second fluid 210 ejected from the solenoid valve head 200.

That is, the Piezo pipette head 100 may eject the first fluid 110 by using a Piezo pipette, and receive the first fluid 110 supplied through a pump 400, which will be described later.

That is, the pump 400 may suck the first fluid 110.

Here, the first fluid 110 ejected from the Piezo pipette head 100 may be imaged by an optical imaging device 500, and thus a volume of the ejected first fluid 110 may be accurately measured.

That is, since the first fluid 110 ejected from the Piezo pipette head 100 has a very small volume, the first fluid 110 can be ejected in a very small spherical shape immediately after being ejected unlike the second fluid 210 ejected from the solenoid valve head 200.

Thus, when the first fluid 110 is imaged by the optical imaging device 500, the volume of the first fluid 110 may be accurately measured due to the spherical shape thereof.

Here, the optical imaging device 500 may move up and down, and a location thereof may be automatically or manually changed in accordance with a location of the first fluid 110 ejected from the Piezo pipette head 100.

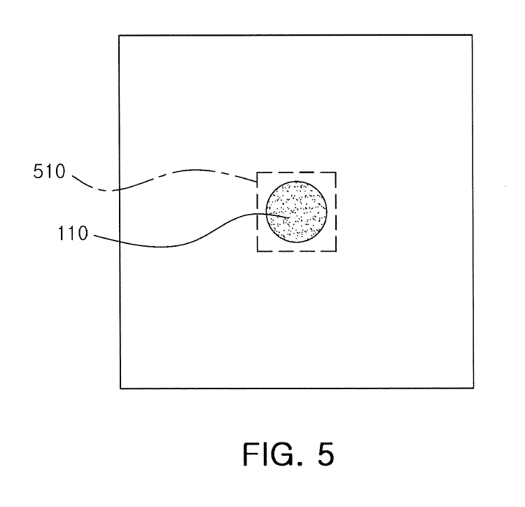

In this case, the optical imaging device 500 may include an image inspection region 510 (See FIG. 5) to correspond to the first fluid, in order to accurately measure the volume of the first fluid 110, and the volume of the first fluid 110 disposed within the image inspection region 510 may be easily calculated through the image of the first fluid 110.

If a numerical value of the volume of the first fluid 110 measured by the optical imaging device 500 exceeds a pre-set numerical value range of volume, the amount of the first fluid 110 ejected from the Piezo pipette head 100 may be controlled by adjusting a voltage applied to the Piezo pipette head 100 or a voltage application time.

Here, the foregoing sequential process may be controlled by a setting control unit (not shown), and the setting control unit (not shown) may be disposed in any position of the fluid ejection device 10 according to the embodiment of the present invention.

Meanwhile, the Piezo pipette head 100 may move to eject the first fluid 110 to a bio-chip 600, and to this end, the Piezo pipette head 100 may be coupled to a transfer unit 700.

The transfer unit 700 is movably connected to a rail unit 800 provided in a body 900 forming the exterior of the fluid ejection device 10 according to the embodiment of the present invention, and may transfer the Piezo pipette head 100 in a direction.

The solenoid valve head 200 may be an element for ejecting the second fluid 210 having a volume relatively larger than that of the first fluid 110 ejected from the Piezo pipette head 100.

Further, the second fluid 210 ejected from the solenoid valve head 200 may be supplied through the pump 400.

That is, the pump 400 may suck the second fluid 210.

Here, the solenoid valve head 200 may be connected to the Piezo pipette head 100 through a connection unit 150, so that the solenoid valve head 200 may move together with the Piezo pipette head 100.

That is, the solenoid valve head 200 may be connected to the transfer unit 700 together with the Piezo pipette head 100, and may also be transferred as the transfer unit 700 moves along the rail unit 800.

However, the solenoid valve head 200 may be connected the transfer unit 700 independently from the Piezo pipette head 100, such that the solenoid valve head 200 may move independently from the Piezo pipette head 100.

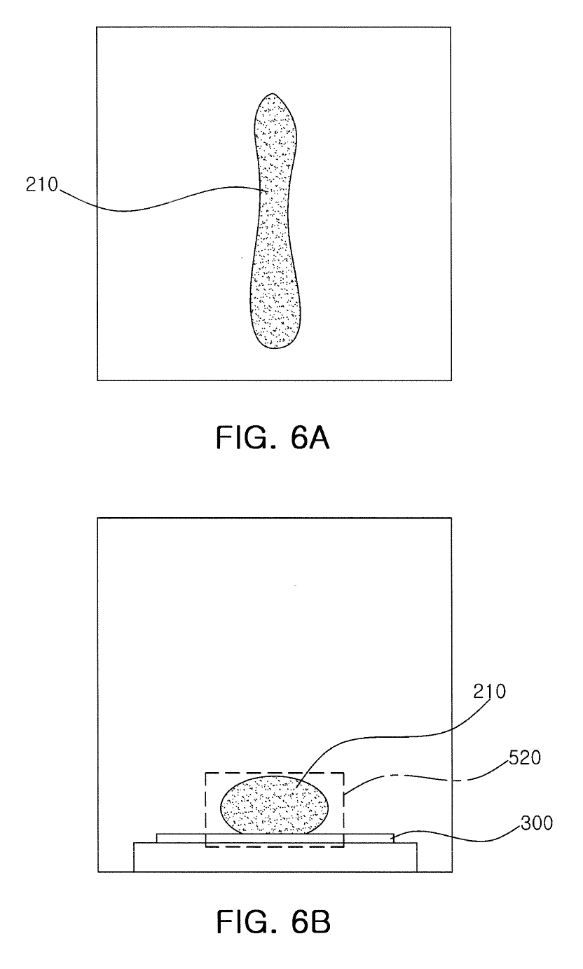

Here, the second fluid 210 ejected from the solenoid valve head 200 may have a shape of an elongated water jet (See FIG. 6A), rather than a spherical shape, and due to such characteristics, it is difficult to measure the volume of the second fluid 210 through the optical imaging device 500.

Thus, it is actually impossible to measure the volume of the second fluid 210 immediately after being ejected from the solenoid valve head 200 by capturing an image of the second fluid 210 through the optical imaging device 500.

This will be described with reference to FIGS. 4 through 6B, in detail. A method of measuring the volume of the second fluid 210 will now be described below.

The fluid collection unit 300 is an element for measuring the volume of the second fluid 210 ejected from the solenoid valve head 200, and enables the second fluid 210 to be formed on one surface thereof.

That is, the fluid collection unit 300 may enable the volume of the second fluid 210 ejected from the solenoid valve head 200 to be measured before the second fluid 210 is ejected to the bio-chip 600, thereby enhancing accuracy in a fixed quantity supply of the second fluid 210 to the bio-chip 600 or the like.

In other words, in order to accurately measure the volume of a fluid by the optical imaging device 500, the shape of the fluid to be measured needs to have a spherical shape, but the second fluid 210 ejected from the solenoid valve head 200 has a shape of an elongated water jet, rather than a spherical shape.

Thus, a unit for allowing the second fluid 210 ejected from the solenoid valve head 200 to have a spherical shape is required, and in the embodiment of the present invention, the unit may be implemented by the fluid collection unit 300.

The fluid collection unit 300 may have a hydrophobic wafer repellent coated surface on an upper surface thereof, and accordingly, when the second fluid 210 is formed on the fluid collection unit 300, the second fluid 210 may stably have a spherical shape.

Accordingly, the second fluid 210 formed to have a spherical shape on the water repellent coated surface of the fluid collection unit 300 may be imaged by the optical imaging device 500, whereby the volume of the second fluid 210 ejected from the solenoid valve head 200 may be accurately measured.

In this case, the optical imaging device 500 may include an image inspection region 520 (see FIG. 6B) to correspond to the second fluid 210, in order to accurately measure the volume of the second fluid 210, and the volume of the second fluid 210 disposed within the image inspection region 520 may be easily calculated through the image of the second fluid 210.

When a numerical value of the volume of the second fluid 210 measured by the optical imaging device 500 exceeds a pre-set numerical value range of volume, a valve opening time applied to the solenoid valve head 200 may be adjusted to control the amount of the second fluid 210 ejected from the solenoid valve head 200.

Here, the foregoing sequential process may be controlled by the setting control unit (not shown) as mentioned above, and the setting control unit (not shown) may be disposed in any position of the fluid ejection device 10 according to the embodiment of the present invention.

Meanwhile, an air blower 310 may be disposed to be adjacent to the fluid collection unit 300. The air blower 310 may supply air to the fluid collection unit 300 to dry the surface of the fluid collection unit 300 in a short time.

Thus, the volume of the second fluid 210 collected in the fluid collection unit 300 may be repeatedly measured in a short time.

Meanwhile, the fluid ejection device 10 according to the embodiment of the present invention may include the body 900 forming the exterior thereof. The elements such as the Piezo pipette head 100, the solenoid valve head 200, and the fluid collection unit 300 may be mounted in the body 900.

The body 900 may include a plurality of legs (not shown), heights of which may be individually adjusted. Accordingly, the body 900 may be maintained in a horizontal state.

In addition, the body 900 may include a receiving space allowing supplementary devices to be installed therein, and may have wheels to facilitate movement.

Also, the fluid ejection device 10 according to the embodiment of the present invention may further include an environment control unit 940 and a cover 920.

Here, the bio-chip 600 provided in the body 900 may include a biological tissue, and may be very sensitively reacted to a surrounding environment (in particular, a temperature or humidity).

For example, the bio-chip 600 including a biological tissue may be easily dried or deformed in a dry environment.

Thus, in consideration of this, the fluid ejection device 10 according to an embodiment of the present invention may include the environment control unit 940 and further include the cover 920 protecting the bio-chip 600 or the like from an external environment.

More specifically, the environment control unit 940 may automatically or manually control a temperature or humidity of the internal space of the body 900, namely, the surrounding environment of the Piezo pipette head 100 and the solenoid valve head 200.

That is, the environment control unit 940 may include an ejection hole 945 protruding to the internal space of the body 900, and supply cold air or warm air through the ejection hole 945.

Also, the environment control unit 940 may control humidity by supplying certain vapor through the ejection hole 945 and maintain an environment required for preserving the bio-chip 600 for several hours.

FIG. 4 is a conceptual diagram for explaining the fluid ejection device according to the embodiment of the present invention. FIG. 5 is a schematic view showing an image of a first fluid that is ejected from a piezo pipette head, captured by an optical imaging device provided in the fluid ejection device according to the embodiment of the present invention.

FIG. 6A is a schematic view showing an image of a second fluid after being immediately ejected from a solenoid valve head captured by the optical imaging device provided in the fluid ejection device according to the embodiment of the present invention. FIG. 6B is a schematic view showing an image of the second fluid in contact with a fluid collection unit after being ejected from the solenoid valve head captured by the optical imaging device provided in the fluid ejection device according to the embodiment of the present invention.

With reference to FIGS. 4 through 6B, the fluid ejection device 10 according to the embodiment of the present invention may include the Piezo pipette head 100 and the solenoid valve head 200 in order to eject various volumes of fluids.

The first fluid 110 ejected from the Piezo pipette head 100 has a very small volume. Thus, the first fluid 110 immediately after being ejected from the Piezo pipette head 100 may be imaged by the optical imaging device 500 to thereby accurately measure the volume of the first fluid 110.

That is, since the first fluid 110 ejected from the Piezo pipette head 100 has a very small spherical shape as shown in FIG. 5, when the first fluid 110 is imaged by the optical imaging device 500, the volume of the first fluid 110 may be accurately measured due to the spherical shape thereof.

In this case, the optical imaging device 500 may include the image inspection region 510 to correspond to the first fluid 110, in order to accurately measure the volume of the first fluid 110, and the volume of the first fluid 110 may be easily calculated through the image of the first fluid 110 disposed within the image inspection region 510.

Also, as mentioned above, when a numerical value of the volume of the first fluid 110 measured by the optical imaging device 500 exceeds a pre-set numerical value range of volume, a voltage applied to the Piezo pipette head 100 or a voltage application time may be adjusted by the setting control unit (not shown) to thereby control the amount of the first fluid 110 ejected from the Piezo pipette head 100.

Meanwhile, since the second fluid 210 ejected from the solenoid valve head 200 has a relatively large volume, as compared to the first fluid 110 ejected from the Piezo pipette head, it may has a shape of an elongated water jet, rather than a spherical shape, as shown in FIG. 6A.

Thus, due to the characteristics of the second fluid 210 as mentioned above, it is difficult to measure the volume of the second fluid 210 immediately after being ejected from the solenoid valve head 200, by using the optical imaging device 500.

That is, a fluid needs to have a spherical shape in order to accurately measure the volume of the fluid imaged by the optical imaging device 500.

However, as shown in FIG. 6A, the second fluid 210 immediately after being ejected from the solenoid valve head 200 does not have a spherical shape. Thus, a separate measurement unit is required to accurately measure the volume of the second fluid 210.

Thus, the second fluid 210 ejected from the solenoid valve head 200 is formed on one surface of the fluid collection unit 300 to have a spherical shape, and the second fluid 210 in this status is imaged by the optical imaging device 500, thereby measuring the volume of the second fluid 210.

Here, as shown in FIG. 6B, when the second fluid 210 is formed on the water repellent coated surface of the fluid collection unit 300, the optical imaging device 500 may include the image inspection region 520 to correspond to the second fluid 210, thereby accurately measuring the volume of the second fluid 210 through the image of the second fluid 210.

Meanwhile, when a numerical value of the volume of the second fluid 210 measured by the optical imaging device 500 exceeds a pre-set numerical value range of volume, a valve opening time applied to the solenoid valve head 200 may be adjusted to control the amount of the second fluid 210 ejected from the solenoid valve head 200 as mentioned above.

According to the embodiment described above, the fluid ejection device 10 according to the embodiment of the present invention includes the Piezo pipette head 100 and the solenoid valve head 200, such that various volumes of fluids may be ejected from a single device.

Also, before the first fluid 110 or the second fluid 210 substantially ejected from Piezo pipette head 100 or the solenoid valve head 200 is substantially ejected to the bio-chip 600 including abiological tissue, the volume of the ejected fluid may be accurately measured in advance by using the optical imaging device 500 and the fluid collection unit 300.

Accordingly, the volume of the ejected fluid may be accurately measured to enhance accuracy in a fixed quantity supply of the fluid ejected to the bio-chip 600, thus maximizing precision of the experiment.

Also, even when ejected fluids are varied, since the measurement of the volume of a fluid before being ejected to the bio-chip 600 is simply performed, a set-up operation is not necessarily reset, and thus a time for a preparation of an experiment may be reduced.

In addition, a set-up error of an experimenter can be recognized in advance before conducting an experiment, thereby implementing accurate experiment results.

As set forth above, with the fluid ejection device according to the embodiment of the invention, various volumes of fluids can be ejected from a single device.

Further, the volume of a fluid to be ejected can be accurately measured before the fluid is substantially ejected to a bio-chip, and at the same time, when the measured volume is different from a pre-set volume, the measured volume can be corrected.

Further, although types of ejected fluids are varied, since it is unnecessary to reset a set-up operation, time for a preparation of an experiment can be reduced.

Furthermore, a set-up error of an experimenter can be recognized in advance before conducting an experiment, thereby implementing accurate experiment results.

While the present invention has been shown and described in connection with the embodiments, it will be apparent to those skilled in the art that modifications and variations can be made without departing from the spirit and scope of the invention as defined by the appended claims.

What is claimed is:

1. A fluid ejection device comprising:
a piezo pipette head ejecting a first fluid;
a solenoid valve head disposed to be adjacent to the piezo pipette head and ejecting a second fluid having a volume relatively larger than that of the first fluid; and
a fluid collection unit allowing the second fluid ejected from the solenoid valve head to be formed thereon to thereby allow the volume of the second fluid to be measured by an optical image device.

2. The device of claim 1, wherein the fluid collection unit includes a hydrophobic water repellent coated surface.

3. The device of claim 1, wherein the fluid collection unit allows the second fluid ejected from the solenoid valve head to be formed to have a spherical shape.

4. The device of claim 1, wherein the optical imaging device images the first fluid ejected from the piezo pipette head or the second fluid formed on the fluid collection unit to thereby allow the volume of the first fluid or the second fluid to be measured.

5. The device of claim 4, wherein the optical imaging device includes an image inspection region to correspond to an image of the first fluid or the second fluid in order to accurately measure the volume of the first fluid or the second fluid.

6. The device of claim 4, further comprising a setting control unit controlling a voltage applied to the piezo pipette head or a voltage application time or controlling a valve opening time applied to the solenoid valve head when a numerical value of the volume of the first fluid or the second fluid measured by the optical image device exceeds a pre-set numerical value range of volume.

7. The device of claim 1, further comprising a transfer unit allowing the piezo pipette head and the solenoid valve head to move simultaneously or individually.

8. The device of claim 1, further comprising a pump provided to suck the first fluid and the second fluid stored in the piezo pipette head and the solenoid valve head, respectively.

9. The device of claim 1, further comprising an environment control unit controlling a temperature or humidity of a surrounding environment of the piezo pipette head or the solenoid valve head.

10. The device of claim 1, further comprising an air blower drying a surface of the fluid collection unit on which the second fluid is formed.
